(19) United States
(12) Patent Application Publication
(10) Pub. No.: US 2023/0229374 A1
(43) Pub. Date: Jul. 20, 2023

(54) SCREEN DISPLAY CONTROL DEVICE, SCREEN DISPLAY CONTROL METHOD, AND PROGRAM

(71) Applicant: FUJIFILM Corporation, Tokyo (JP)

(72) Inventor: Kyota WATANABE, Tokyo (JP)

(73) Assignee: FUJIFILM Corporation, Tokyo (JP)

(21) Appl. No.: 18/186,686

(22) Filed: Mar. 20, 2023

Related U.S. Application Data
(63) Continuation of application No. PCT/JP2021/034253, filed on Sep. 17, 2021.

(30) Foreign Application Priority Data
Sep. 23, 2020 (JP) 2020-158231

(51) Int. Cl. G06F 3/14

(52) U.S. Cl. CPC G06F 3/14; G08B 21/10

(57) ABSTRACT

Provided are a screen display control device, a screen display control method, and a program which realize screen display reflecting dynamically changing importance. An object described above is solved by a screen display control device, a screen display control method, and a program in which a plurality of types of data that is input are acquired, importance of each of the plurality of types of data is determined, an arrangement of display of the plurality of types of data on an entire screen is decided based on the importance of each of the plurality of types of data, and the plurality of types of data are displayed on the screen in the decided arrangement.

### CROSS-REFERENCE TO RELATED APPLICATIONS

The present application is a Continuation of PCT International Application No. PCT/JP2021/034253 filed on Sep. 17, 2021 claiming priority under 35 U.S.C §119(a) to Japanese Patent Application No. 2020-158231 filed on Sep. 23, 2020. Each of the above applications is hereby expressly incorporated by reference, in its entirety, into the present application.

### BACKGROUND OF THE INVENTION

### 1. Field of the Invention

The present invention relates to a screen display control device, a screen display control method, and a program, and particularly relates to a technique for displaying a plurality of types of data on a screen.

### 2. Description of the Related Art

In disaster response work of a local government, a large amount of various types of information, such as weather information and damage situation of a city, are input in real time, and it is necessary to appropriately display the large amount of information on a screen.

JP2003-141670A discloses a device in which a screen for displaying information desired to be viewed by a user is registered in advance and is switched by a shortcut button or the like.

### SUMMARY OF THE INVENTION

A person in charge of the disaster response work makes a decision while selecting necessary information from a large amount of input information. However, in a case in which the person in charge is late in focusing on appropriate information, that case is also influenced the speed of decision making, such as rescue activities and issuance of evacuation orders.

On the other hand, in a display method in which a display item and layout are preset as in the device disclosed in JP2003-141670A, there is a problem that information of which the importance is dynamically changed according to a situation cannot be appropriately expressed.

The present invention has been made in view of such circumstances, and is to provide a screen display control device, a screen display control method, and a program which realize screen display reflecting dynamically changing importance.

In order to achieve the object described above, an aspect of the present invention relates to a screen display control device comprising a memory that stores a command to be executed by a processor, and the processor that executes the command stored in the memory, in which the processor acquires a plurality of types of data that is input, determines importance of each of the plurality of types of data, decides an arrangement of display of the plurality of types of data on an entire screen based on the importance of each of the plurality of types of data, and displays the plurality of types of data on the screen in the decided arrangement.

According to the present aspect, since the arrangement of display of the plurality of types of data on the entire screen is decided based on the importance of each of the plurality of types of data, the screen display reflecting the dynamically changing importance can be realized.

It is preferable that the processor arrange a first type of data having high importance among the plurality of types of data to have a large area or arrange the first type of data to be more conspicuous than types of data other than the first type of data. As a result, the first type of data having high importance can be arranged to be large or to be conspicuous.

It is preferable that, in a case in which importance of a second type of data among the plurality of types of data is increased, the processor arrange a third type of data having lowest importance among types of data other than the second type of data to have a small area or do not display the third type of data. As a result, the area of the second type of data can be relatively increased.

It is preferable that the processor determine that a type of data of which a data input frequency exceeds a threshold value has high importance. As a result, the importance can be appropriately determined.

It is preferable that the processor arrange a fourth type of data among the plurality of types of data to have a certain area. The fourth type of data can always be displayed in a certain area.

It is preferable that the processor display a window that receives input from a user on the screen. The input can be received from the user.

It is preferable that the processor determine the importance of each of the plurality of types of data according to an attribute of a user or a position of the user. As a result, the importance according to the user can be determined.

It is preferable that the processor calculate the importance of each of the plurality of types of data using a common indicator, and compare the importance of the plurality of types of data using the importance calculated using the common indicator. As a result, the importance of the plurality of types of data can be appropriately compared.

It is preferable that the plurality of types of data include at least one of weather information, disaster measure information, earthquake disaster information, or flood damage information. The present aspect is suitable for handling such types of data.

In order to achieve the object described above, another aspect of the present invention relates to a screen display control method comprising an acquisition step of acquiring a plurality of types of data that is input, a determination step of determining importance of each of the plurality of types of data, a decision step of deciding an arrangement of display of the plurality of types of data on an entire screen based on the importance of each of the plurality of types of data, and a display control step of displaying the plurality of types of data on the screen in the decided arrangement.

According to the present aspect, since the arrangement of display of the plurality of types of data on the entire screen is decided based on the importance of each of the plurality of types of data, the screen display reflecting the dynamically changing importance can be realized.

In order to achieve the object described above, still another aspect of the present invention relates to a program causing a computer to execute the screen display control method described above. A computer-readable non-transitory recording medium on which the program is recorded may also be included in the present aspect.

According to the present aspect, since the arrangement of display of the plurality of types of data on the entire screen is decided based on the importance of each of the plurality of types of data, the screen display reflecting the dynamically changing importance can be realized.

According to the present invention, the screen display reflecting the dynamically changing importance can be realized.

### BRIEF DESCRIPTION OF THE DRAWINGS

FIG. 1 is a schematic diagram of a damage situation monitoring system.

FIG. 2 is a configuration diagram of a server.

FIG. 3 is a functional block diagram of the server.

FIG. 4 is a functional block diagram of a screen configuration unit.

FIG. 5 is a functional block diagram of a layout control unit.

FIG. 6 is a functional block diagram of a color control unit.

FIG. 7 is a functional block diagram of an external data reception unit.

FIG. 8 is a functional block diagram of an importance determination data acquisition unit.

FIG. 9 is a functional block diagram of a user attribute acquisition unit.

FIG. 10 is a flowchart showing each step of a screen display control method.

FIG. 11 is an example of a screen displayed on a display.

FIG. 12 is an example of the screen displayed on the display.

FIG. 13 is a diagram showing an example of a screen displayed on a tablet PC.

FIG. 14 is a diagram showing an example of the screen displayed on the tablet PC.

FIG. 15 is a diagram showing an example of a screen displayed on a smartphone.

FIG. 16 is a diagram showing an example of the screen displayed on the display.

FIG. 17 is a diagram showing an example of the screen displayed on the display.

FIG. 18 is a diagram showing an example of a reference table used by an importance determination unit.

### DESCRIPTION OF THE PREFERRED EMBODIMENTS

Hereinafter, preferred embodiments of the present invention will be described in detail with reference to the accompanying drawings.

### Configuration of Damage Situation Monitoring System

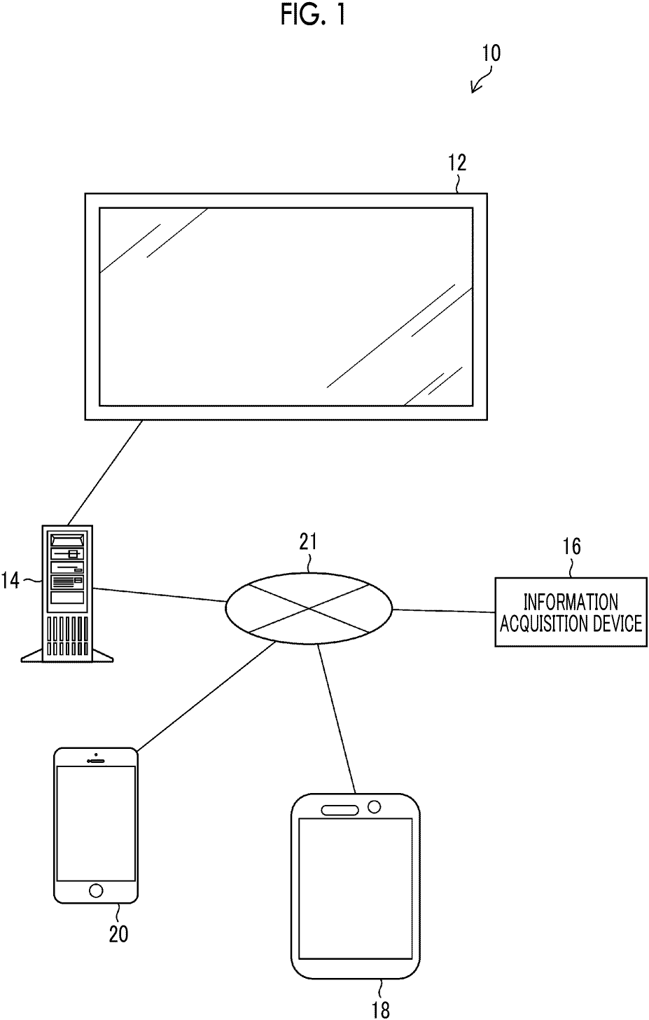

FIG. 1 is a schematic diagram of a damage situation monitoring system 10 according to the present embodiment. As shown in FIG. 1, the damage situation monitoring system 10 includes a display 12, a server 14, an information acquisition device 16, a tablet personal computer (PC) 18, and a smartphone 20.

The display 12 is a display device installed in a disaster measure headquarters of an administrative agency and for allowing a user who is a member of the disaster measure headquarters to visually recognize a plurality of information regarding a disaster. A large-screen plasma display, a multi-sided multi-display in which a plurality of displays are connected, or the like can be applied as the display 12. Instead of the display 12, a projector that projects an image on the screen may be applied.

The server 14 is realized by at least one computer and configures a screen display control device that controls the screen display of the display 12, the tablet PC 18, and the smartphone 20.

The information acquisition device 16 acquires information, such as weather information, disaster measure information, earthquake disaster information, and flood damage information, which consist of sensor data and a system log. The server 14 is connected to able to receive the information from the information acquisition device 16 via a communication network 21, such as the Internet.

Here, the weather information is information including at least one of a rainfall graph, a weather map, a rain cloud distribution diagram, a wave height graph, a wind direction/wind speed graph, a warning/advisory, a temperature graph, or a humidity graph.

The disaster measure information is information including at least one of a shelter map, shelter stockpile/the number of people that can be accommodated/equipment information, list/number graph of residents evacuated to the shelter, requests for supplies/personnel support from the shelter, a sewage/water supply map, a hospital map, the number of people that can be accepted in the hospital, a communication failure area map, a refueling-available gas station map, an operation status of public transportation, fixed point camera position/captured image/streaming video, drive recorder position/captured image/streaming video, investigation drone track/captured image/streaming video, position/image/streaming video of a whiteboard installed at the disaster measure headquarters, or the disaster measure information of other local governments.

The earthquake disaster information is information including at least one of an earthquake intensity distribution diagram, a disaster-stricken house distribution diagram/damaged house image, a fire-stricken house distribution diagram/fire-stricken house image, a road/infrastructure damage distribution diagram, a graph of the number of victims, the number of house damage investigators/investigation materials, position information of house damage investigator, progress of house damage investigation, a log of a house damage investigation conduction content, a house damage investigation result, an inquiry log from the house damage investigator, a house damage report from the resident, a road/infrastructure damage report from the resident, a fire report from the resident, a content of consultation from the resident, or a content posted by resident’s social networking service (SNS).

The flood damage information is information including at least one of a hazard map, a river water level graph, a danger level river map, a map of a damaged portion of an embankment, a flood simulation result, an evacuation route simulation result, an evacuation advisory issuance history, evacuated resident position information, a list of residents requiring support, a flood occurrence map, or a sediment disaster occurrence map.

The tablet PC 18 is an information portable terminal owned by a person concerned with the administrative agency, and is connected to the server 14 via the communication network 21. Although one tablet PC 18 is shown in FIG. 1, a plurality of tablet PCs 18 may be connected to the server 14 via the communication network 21.

The smartphone 20 is an information portable terminal owned by a local resident and is connected to the server 14 via the communication network 21. Although one smartphone 20 is shown in FIG. 1, a plurality of smartphones 20 may be connected to the server 14 via the communication network 21.

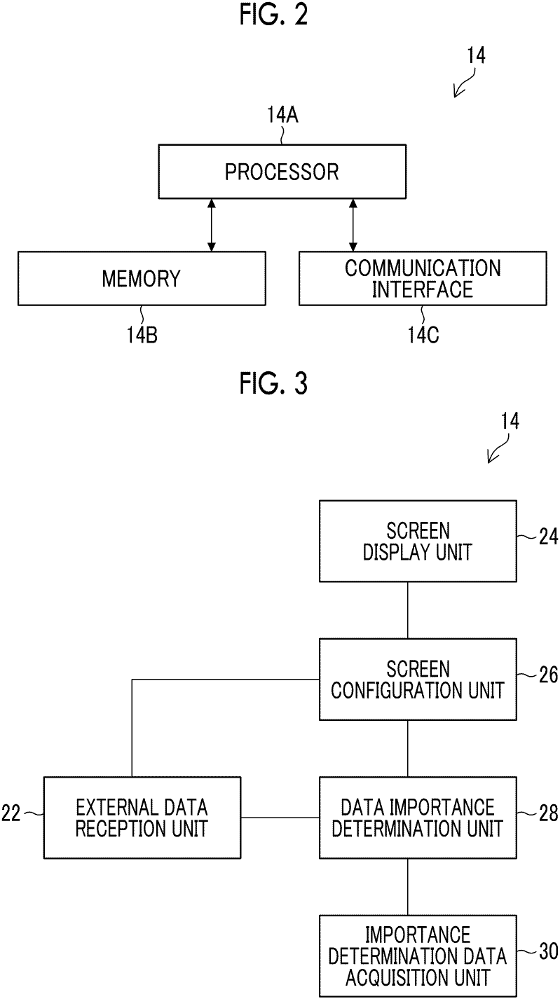

FIG. 2 is a configuration diagram of the server 14. The server 14 comprises a processor 14A, a memory 14B, and a communication interface 14C.

The processor 14A executes a command stored in the memory 14B. A hardware structure of the processor 14A is various processors as shown below. Various processors include a central processing unit (CPU) as a general-purpose processor which functions as various function units by executing software (program), a graphics processing unit (GPU) as a processor specialized in image processing, a programmable logic device (PLD) as a processor of which a circuit configuration can be changed after manufacture, such as a field programmable gate array (FPGA), and a dedicated electric circuit as a processor which has a circuit configuration specifically designed to execute specific processing, such as an application specific integrated circuit (ASIC).

One processing unit may be configured by one of these various processors, or two or more processors of the same type or different types (for example, a plurality of FPGAs, or a combination of a CPU and an FPGA, or a combination of a CPU and a GPU). Moreover, a plurality of function units may be configured by one processor. As a first example in which the plurality of function units are configured by one processor, as represented by a computer such as a client or a server, there is a form in which one processor is configured by a combination of one or more CPUs and software, and this processor operates as the plurality of function units. As a second example thereof, as represented by a system on chip (SoC), there is a form in which a processor that realizes the functions of the entire system including the plurality of function units by one integrated circuit (IC) chip is used. As described above, various function units are configured by one or more of the various processors described above as the hardware structure.

Further, the hardware structures of these various processors are, more specifically, an electric circuit (circuitry) in which circuit elements such as semiconductor elements are combined.

The memory 14B stores the command executed by the processor 14A. The memory 14B includes a random access memory (RAM) and a read only memory (ROM) (not shown). The processor 14A uses the RAM as a work region, executes software by using various programs and parameters including a screen display control program stored in the ROM, and uses the parameters stored in the ROM or the like to execute various pieces of processing of the server 14.

The communication interface 14C controls wired and wireless communication. The server 14 is connected by the communication interface 14C to be able to transmit and receive data to the communication network 21, such as the Internet.

The configurations of the tablet PC 18 and the smartphone 20 are the same as the configuration of the server 14 shown in FIG. 2.

FIG. 3 is a functional block diagram of the server 14. As shown in FIG. 3, the server 14 comprises an external data reception unit 22, a screen display unit 24, a screen configuration unit 26, a data importance determination unit 28, and an importance determination data acquisition unit 30. The functions of the external data reception unit 22, the screen display unit 24, the screen configuration unit 26, the data importance determination unit 28, and the importance determination data acquisition unit 30 are realized by the processor 14A.

The external data reception unit 22 receives (an example of acquisition) a plurality of types of data input from the information acquisition device 16, the tablet PC 18, and the smartphone 20 via the communication network 21. The screen display unit 24 displays the plurality of types of data received by the external data reception unit 22 on the screen, such as the display 12, in an arrangement decided by the screen configuration unit 26. The screen configuration unit 26 controls a configuration of a display screen.

The data importance determination unit 28 determines importance of each of the plurality of types of data received by the external data reception unit 22. The importance determination data acquisition unit 30 acquires importance determination data for the data importance determination unit 28 to determine the importance.

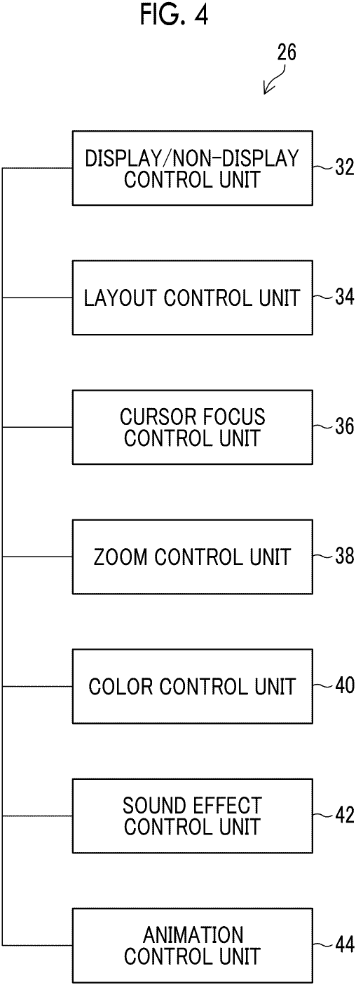

FIG. 4 is a functional block diagram of the screen configuration unit 26. As shown in FIG. 4, the screen configuration unit 26 comprises a display/non-display control unit 32, a layout control unit 34, a cursor focus control unit 36, a zoom control unit 38, a color control unit 40, a sound effect control unit 42, and an animation control unit 44.

The display/non-display control unit 32 controls display and non-display of each type of data of the plurality of types of data on the screen. The layout control unit 34 controls the layout of the entire screen. The cursor focus control unit 36 controls an operation at a focus position of a cursor. The zoom control unit 38 controls enlargement and reduction of the display on the screen. The color control unit 40 controls a color of the screen display. The sound effect control unit 42 controls a sound effect in speakers (not shown) of the display 12, the tablet PC 18, and the smartphone 20. The animation control unit 44 controls animation display.

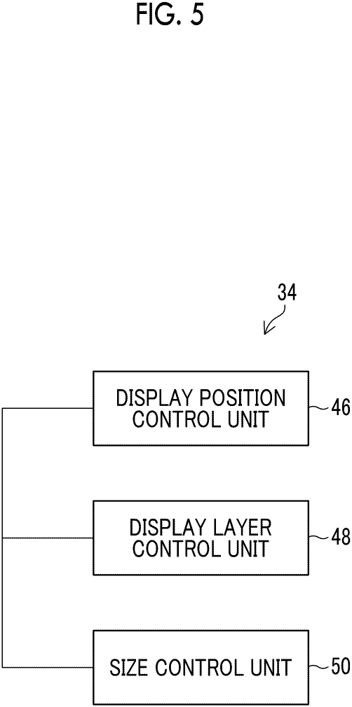

FIG. 5 is a functional block diagram of the layout control unit 34. As shown in FIG. 5, the layout control unit 34 comprises a display position control unit 46, a display layer control unit 48, and a size control unit 50.

The display position control unit 46 controls a display position of each type of data of the plurality of types of data. The display layer control unit 48 controls a display layer of each type of data of the plurality of types of data. The size control unit 50 controls a display size of each type of data of the plurality of types of data.

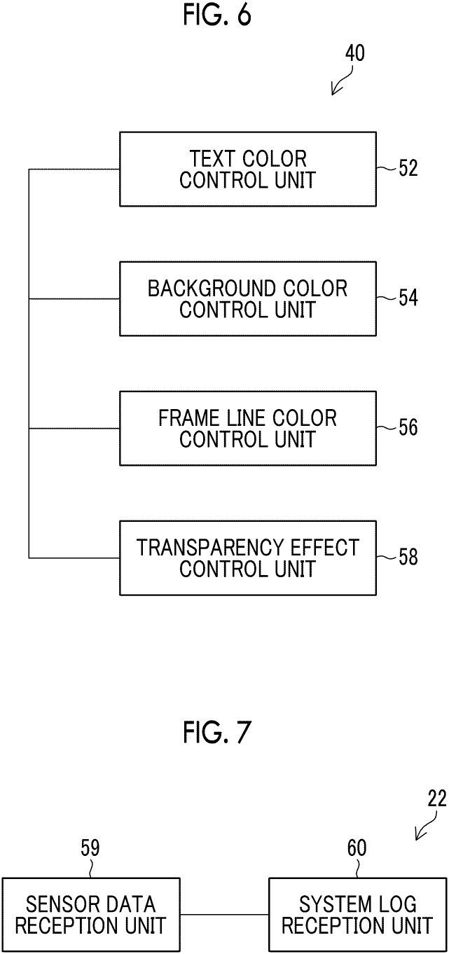

Moreover, FIG. 6 is a functional block diagram of the color control unit 40. As shown in FIG. 6, the color control unit 40 comprises a text color control unit 52, a background color control unit 54, a frame line color control unit 56, and a transparency effect control unit 58.

The text color control unit 52 controls a color of a text. The background color control unit 54 controls a background color. The frame line color control unit 56 controls a color of a frame line. The transparency effect control unit 58 controls a transparency effect.

With the screen configuration unit 26 configured in this way, it is possible to realize the display screen to which various effects are imparted.

FIG. 7 is a functional block diagram of the external data reception unit 22. As shown in FIG. 7, the external data reception unit 22 comprises a sensor data reception unit 59 and a system log reception unit 60.

The sensor data reception unit 59 receives the sensor data. The sensor data is, for example, temperature data obtained from a temperature sensor. The system log reception unit 60 receives the system log. The system log is, for example, the house damage report from the resident.

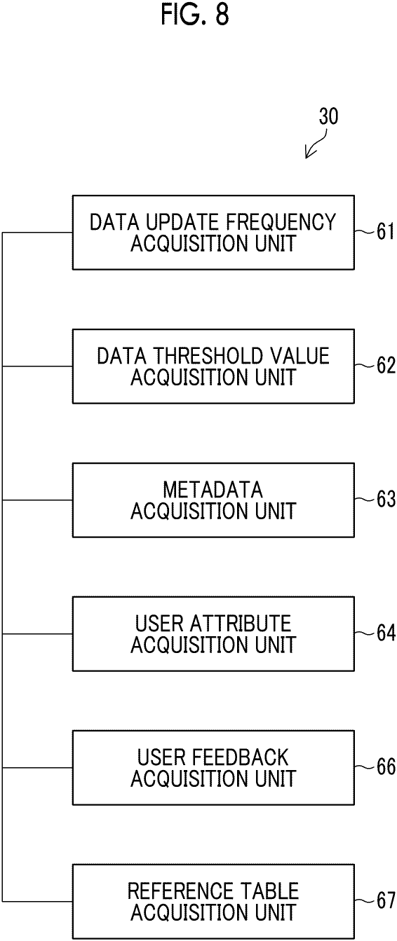

FIG. 8 is a functional block diagram of the importance determination data acquisition unit 30. As shown in FIG. 8, the importance determination data acquisition unit 30 comprises a data update frequency acquisition unit 61, a data threshold value acquisition unit 62, a metadata acquisition unit 63, a user attribute acquisition unit 64, a user feedback acquisition unit 66, and a reference table acquisition unit 67.

The data update frequency acquisition unit 61 acquires an update frequency of each type of data input from the information acquisition device 16. The data threshold value acquisition unit 62 acquires a threshold value of each type of data. The threshold value of data may be a threshold value for comparison with a value of data itself, may be a threshold value for comparison with the update frequency of data, or may be a threshold value for comparison with a data input frequency.

The metadata acquisition unit 63 acquires metadata of each type of data. The user attribute acquisition unit 64 acquires attribute information of the users of the server 14, the tablet PC 18, and the smartphone 20. The user feedback acquisition unit 66 acquires information fed back from the user. The reference table acquisition unit 67 acquires an importance reference table represented by a common indicator for comparing the importance of the plurality of types of data.

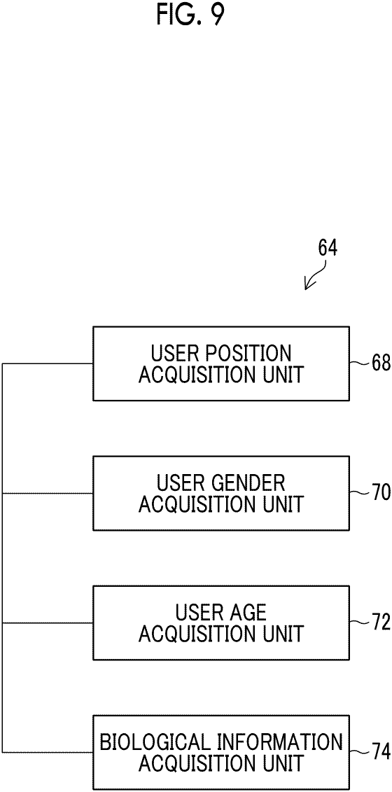

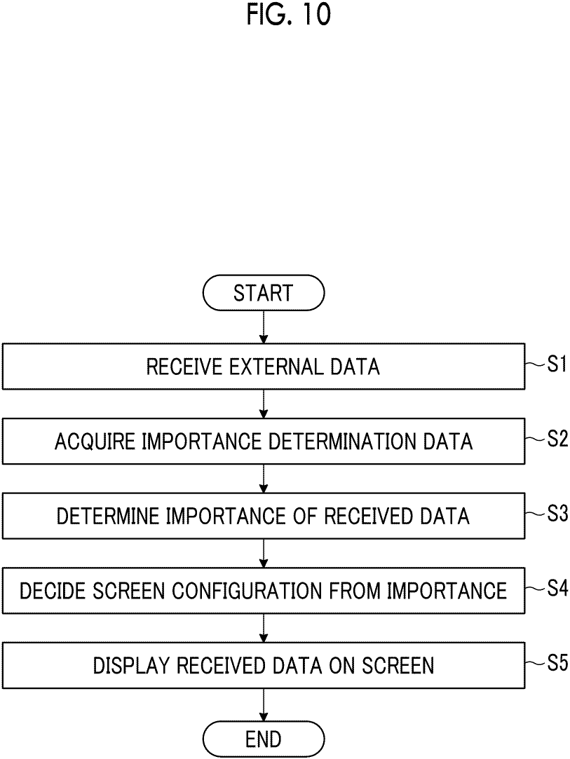

FIG. 9 is a functional block diagram of the user attribute acquisition unit 64. As shown in FIG. 9, the user attribute acquisition unit 64 comprises a user position acquisition unit 68, a user gender acquisition unit 70, a user age acquisition unit 72, and a biological information acquisition unit 74. The user position acquisition unit 68 acquires information on a current position of the user. The user gender acquisition unit 70 acquires information on a gender of the user. The user age acquisition unit 72 acquires information on an age of the user. The information on the current position, the gender, and the age of the user may be registered in the memory 14B in advance, or may be input by the user on each occasion through an input interface. The biological information acquisition unit 74 acquires biological information of the user. The biological information includes, for example, a facial expression, a voice, a posture, a body temperature, a blood pressure, a pulse, and a heart rate. The biological information may be automatically acquired by using a sensor, or may be input by a user on each occasion through the input interface.

The functional configurations of the tablet PC 18 and the smartphone 20 are the same as the functional configuration of the server 14 shown in FIGS. 3 to 9. That is, each of the tablet PC 18 and the smartphone 20 configures the screen display control device.

### Screen Display Control Method: First Embodiment

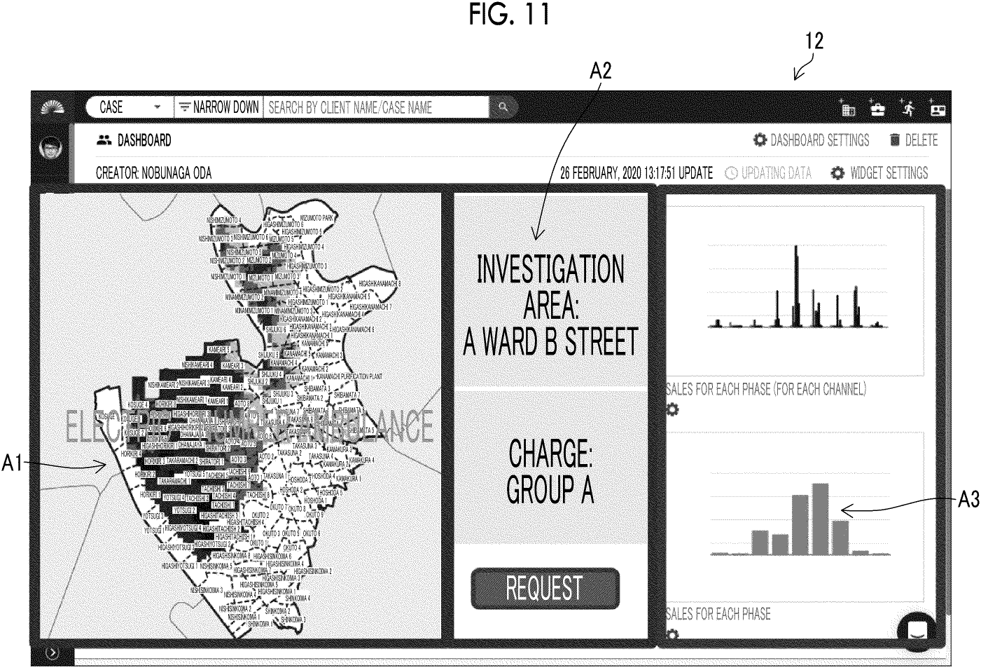

FIG. 10 is a flowchart showing each step of a screen display control method by the damage situation monitoring system 10. The screen display control method according to the first embodiment is realized by executing the screen display control program stored in the memory 14B by the processor 14A of the server 14. The screen display control program may be provided by a computer-readable non-transitory recording medium. In this case, the server 14 may read the screen display control program from the non-transitory recording medium and store the read screen display control program in the memory 14B.

Here, an example will be described in which the user monitors the damage situation on the display 12 installed in the disaster measure headquarters in a case in which the earthquake disaster occurs.

In step S1 (an example of an acquisition step), the external data reception unit 22 acquires a plurality of types of external data from the information acquisition device 16 via the communication network 21.

Here, as one of the information acquisition devices 16, a drone equipped with a camera is used. The drone captures an image of a disaster-stricken area with the camera, extracts the disaster-stricken house by an image processing technique, determines a degree of the disaster, and transmits disaster-stricken house information to the server 14. The disaster-stricken house information includes a position of the house, an image, and the degree of damage expressed as a numerical value. As the number of disaster-stricken houses is larger, the number of times the drone transmits the disaster-stricken house information to the server 14 is larger.

In step S2, the importance determination data acquisition unit 30 acquires the importance determination data for determining the importance of each of the plurality of types of data acquired in step S1. Here, the importance determination data acquisition unit 30 calculates a reception frequency of the disaster-stricken house information within a certain period in the past as the data for determining the importance of the received disaster-stricken house information.

In step S3 (an example of a determination step), the data importance determination unit 28 determines the importance of each type of data of the plurality of types of data acquired in step S1 based on the importance determination data acquired in step S2. The importance is expressed as numerical value data that serves as the common indicator. In this way, the importance of each of the plurality of types of data is calculated using the common indicator, and the data importance determination unit 28 compares the importance of the plurality of types of data using the importance calculated using the common indicator.

Here, in a case in which the reception frequency (an example of a data input frequency) of the disaster-stricken house information from the drone exceeds the threshold value acquired by the data threshold value acquisition unit 62, the data importance determination unit 28 determines the importance of the disaster-stricken house information is increased, and notifies the screen configuration unit 26 of the increase in the importance of the disaster-stricken house information. On the other hand, in a case in which the reception frequency of the disaster-stricken house information falls below the threshold value, the data importance determination unit 28 determines that the importance of the disaster-stricken house information is decreased, and notifies the screen configuration unit 26 of the decrease in the importance of the disaster-stricken house information. That is, the importance of the disaster-stricken house information received from the drone is dynamically changed depending on the reception frequency.

In step S4 (an example of a decision step), the screen configuration unit 26 decides the arrangement (screen configuration) of display of the plurality of types of data on the entire screen of the display 12 based on the importance of each of the plurality of types of data determined step S3.

For example, the screen configuration unit 26 arranges a first type of data having high importance among the plurality of types of data to have a large area or arranges the first type of data to be more conspicuous than types of data other than the first type of data. Moreover, in a case in which importance of a second type of data among the plurality of types of data is increased, the screen configuration unit 26 arranges a third type of data having lowest importance among types of data other than the second type of data to have a small area or does not display the third type of data.

Further, the screen configuration unit 26 may arrange a fourth type of data among the plurality of types of data to have a certain area. The screen configuration unit 26 may display a window that receives the input from the user on the screen.

In step S5 (an example of a display control step), the screen display unit 24 displays the plurality of types of data acquired in step S1 on the display 12 in the arrangement decided in step S4.

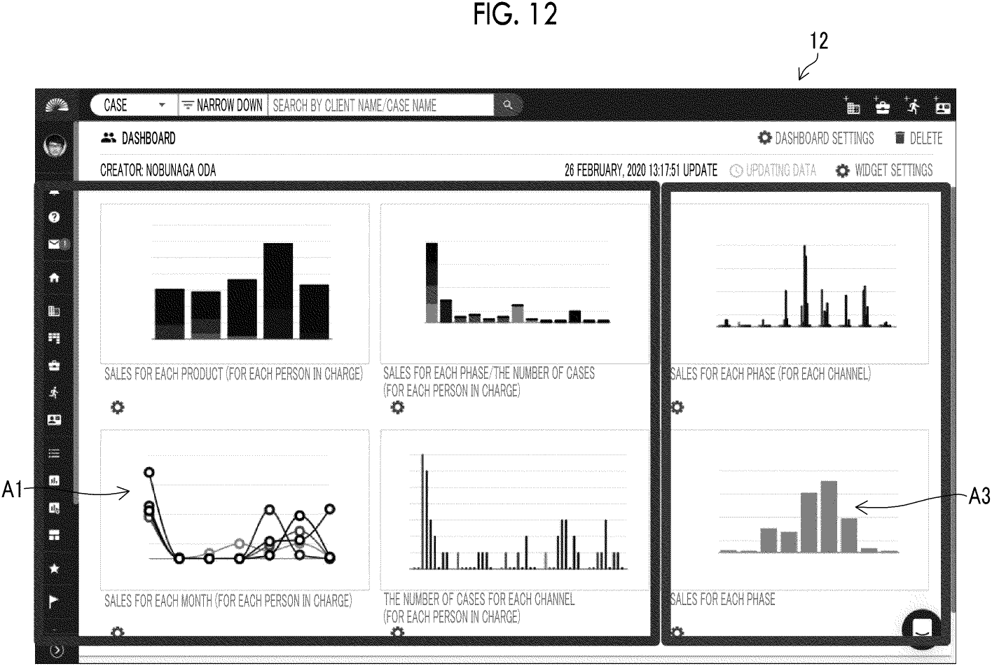

FIG. 11 is an example of the screen displayed on the display 12. In the example shown in FIG. 11, the display screen of the display 12 includes a dynamic display region A1 which is a dynamic display area in which the display is controlled by priority, a user input region A2 which functions as the input interface of the user, and a fixed display region A3 in which a type of data (an example of a fourth type of data) designated by the user is always displayed.

Here, the screen configuration unit 26 receives the update of the importance of the disaster-stricken house information, and preferentially arranges the disaster-stricken house information (an example of a first type of data) in a case in which the importance is higher than the current value. That is, in the dynamic display region A1, the screen configuration unit 26 arranges the disaster-stricken house information to have a large area or arranges the disaster-stricken house information to be more conspicuous than types of data other than the disaster-stricken house information.

Here, arranging the disaster-stricken house information to be conspicuous includes arranging the disaster-stricken house information at a position close to the center of the screen, displaying the frame line thickly, and displaying the color of the frame line in red. Moreover, by arranging types of data other than the disaster-stricken house information inconspicuously, the disaster-stricken house information is relatively conspicuous. Arranging the types of data other than the disaster-stricken house information inconspicuously includes arranging the types of data other than the disaster-stricken house information at an edge of the screen, displaying the frame line thinly, and displaying the color of the frame line in black.

It should be noted that, in a case in which the disaster-stricken house information is not arranged on the current screen (in a non-display case), the screen configuration unit 26 generates a map in which the disaster-stricken house information is mapped and arranges the map in the dynamic display region A1.

Moreover, the screen configuration unit 26 arranges a form (an example of a window that receives the input from the user) that transmits an investigation request to a person in charge of investigation related to the disaster-stricken house information in the user input region A2. In order to secure the dynamic display region A1 in which the map is displayed and the user input region A2 in which the form is displayed, the screen configuration unit 26 arranges information having low importance (an example of a third type of data) among items arranged in the dynamic display region A1 to have small area or does not display the information.

On the other hand, in a case in which the importance of the disaster-stricken house information received by the screen configuration unit 26 is lower than the current value, in the dynamic display region A1, the screen configuration unit 26 arranges the disaster-stricken house information to have a small area or arranges the disaster-stricken house information to be less conspicuous than types of data other than the disaster-stricken house information.

The screen configuration unit 26 may not display the map to which the disaster-stricken house information is mapped. In this case, the screen configuration unit 26 arranges the information having relatively high importance in that case, instead of the map. Further, the screen configuration unit 26 also does not display the related form in the user input region A2 at the same time. The user input region A2 itself may be not displayed.

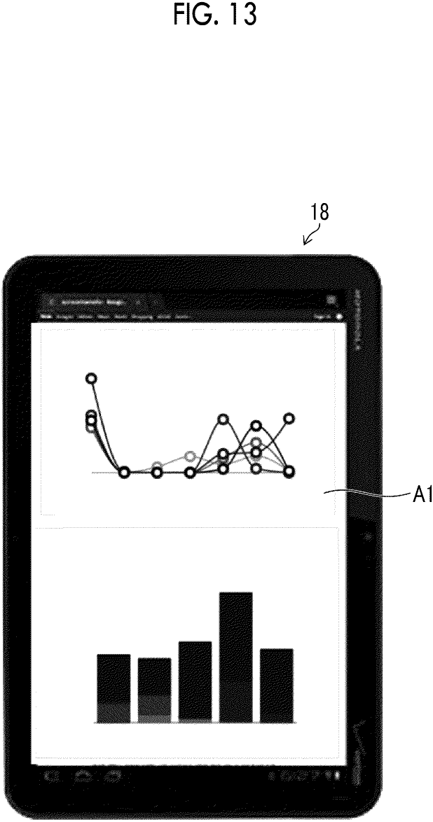

FIG. 12 is an example of the screen displayed on the display 12 in this case. In the example shown in FIG. 12, a plurality of types of information are arranged in the dynamic display region A1 instead of the map, the user input region A2 is not displayed, and the dynamic display region A1 is arranged to be widened by an amount corresponding to the user input region A2. A display content of the fixed display region A3 is the same as the example shown in FIG. 11.

It should be noted that although the arrangement position and the area of the fixed display region A3 are fixed, the display content may be changed. For example, a configuration may be adopted in which a portion of the map in which there is a risk of collapse is arranged in red, and the display content may be changed in real time and arranged, such as arranging a road that cannot be used due to the disaster in red.

### Second Embodiment

In the second embodiment, an example will be described in which an investigator, such as the house damage investigator, conducts the damage investigation using the tablet PC 18 at a disaster site. Here, it is assumed that the screen display control program (damage situation monitoring application) is executed on the tablet PC 18.

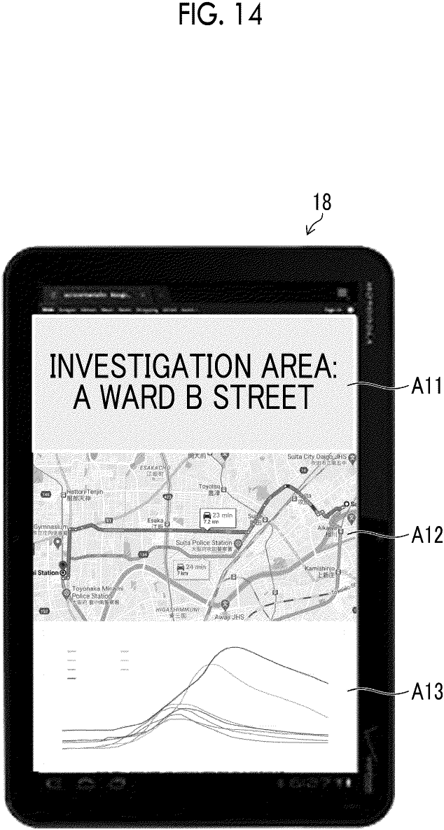

FIG. 13 is a diagram showing an example of the screen displayed on the tablet PC 18 owned by the investigator. As shown in FIG. 13, on the display screen of the tablet PC 18, the dynamic display region A1 which is the dynamic display area in which the display is controlled by the priority is arranged.

In the state shown in FIG. 13, the external data reception unit 22 of the tablet PC 18 receives damage investigation request information from the server 14 of the disaster measure headquarters.

The tablet PC 18 determines the priority from the attribute of the user, and preferentially arranges and displays the data having a higher priority among the plurality of types of data, which are received, on the screen. Here, the user attribute acquisition unit 64 of the importance determination data acquisition unit 30 acquires that the user is the investigator as the attribute of the user. The data importance determination unit 28 determines that the information of the damage investigation request has a high priority based on the attribute of the user. Based on the determination, the screen configuration unit 26 decides the arrangement in which the information of the damage investigation request is prioritized. The screen display unit 24 is displayed on the screen of the tablet PC 18 in the arrangement decided by the screen configuration unit 26.

Subsequently, the tablet PC 18 recalculates the importance of the data according to the new attribute of the user, and preferentially displays the data related to the recalculated importance. Here, the user attribute acquisition unit 64 recalculates the importance of the data using a destination (investigation location) as the new attribute of the user. Moreover, the user position acquisition unit 68 acquires the current position of the user.

The data importance determination unit 28 determines that a route from the current position to the investigation location and water level data of the river in the vicinity of the investigation location are important as the data related to the position of the investigation location. The screen configuration unit 26 decides the arrangement in which the route from the current position to the investigation location and the water level data of the river in the vicinity of the investigation location are prioritized. The screen display unit 24 is displayed on the screen of the tablet PC 18 in the arrangement decided by the screen configuration unit 26.

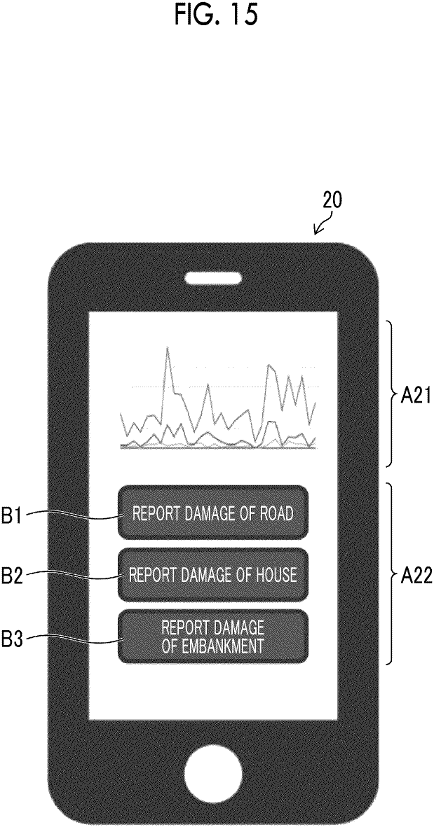

FIG. 14 is a diagram showing an example of the screen displayed on the tablet PC 18 in this case. As shown in FIG. 14, the display screen of the tablet PC 18 includes a region A11 in which the investigation request information is displayed, a region A12 in which the information on the route from the current position to the investigation location is displayed, and a region A13 in which the information on the water level of the river in the vicinity of the investigation location is displayed.

In this way, by determining the importance using the attribute of the user, it is possible to realize the screen display reflecting the dynamically changing importance for the investigator.

Here, the screen configuration is decided in the tablet PC 18 and is displayed on the screen of the tablet PC 18, but processing of deciding the screen configuration may be conducted in the server 14 and the screen configuration may be displayed on the screen of the tablet PC 18 based on a command from the server 14.

### Third Embodiment

In the third embodiment, an example will be described in which the resident receives disaster information on the smartphone in a case in which disaster occurs and reports the damage to the city. Here, it is assumed that the screen display control program (damage situation monitoring application) is executed on the smartphone 20.

The data importance determination unit 28 of the smartphone 20 owned by the resident determines the water level data of the river in the vicinity of the current position of the resident, among the plurality of types of data, as the information having high importance. It should be noted that the user position acquisition unit 68 acquires the current position of the resident.

The screen configuration unit 26 decides the arrangement in which the water level data of the river in the vicinity of the current position of the resident is prioritized as the disaster information. Moreover, the screen configuration unit 26 arranges a user interface on which the damage information of the city can be input. The screen display unit 24 is displayed on the screen of the smartphone 20 in the arrangement decided by the screen configuration unit 26.

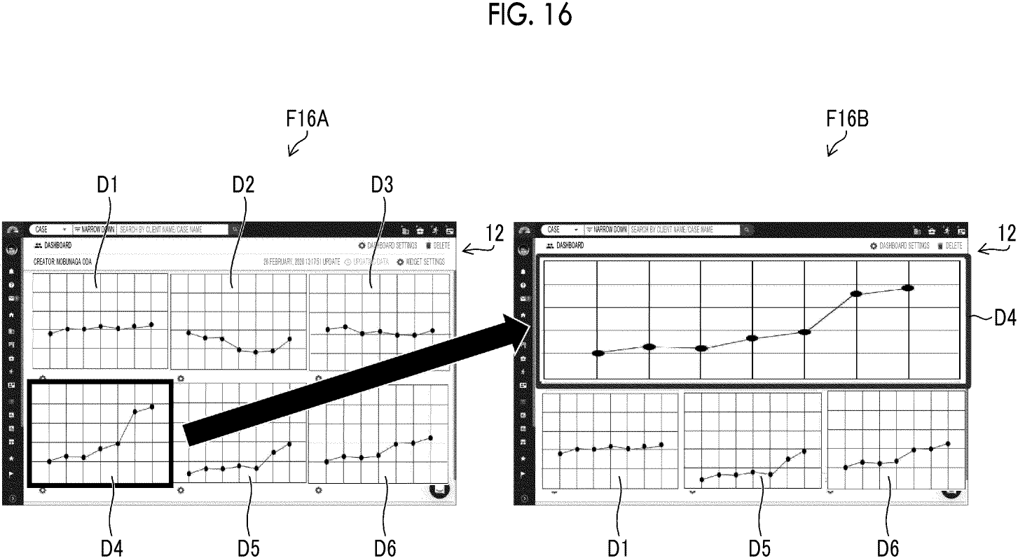

FIG. 15 is a diagram showing an example of the screen displayed on the smartphone 20. As shown in FIG. 15, the display screen of the smartphone 20 includes a region A21 in which the information on the water level of the river in the vicinity of the current position of the resident is displayed and a region A22 in which a user interface for reporting the damage is displayed.

In the region A22, a button B1 for reporting the damage of the road, a button B2 for reporting the damage of the house, and a button B3 for reporting the damage of the embankment are arranged. The resident who has witnessed the damage can input the information using these buttons to transmit the information as a log to the server 14 of the disaster measure headquarters.

In this way, by determining the importance using the attribute of the user, it is possible to realize the screen display reflecting the dynamically changing importance for the resident.

Here, the screen configuration is decided in the smartphone 20 and is displayed on the screen of the smartphone 20, but processing of deciding the screen configuration may be conducted in the server 14 and the screen configuration may be displayed on the screen of the smartphone 20 based on a command from the server 14.

### Fourth Embodiment

In the fourth embodiment, an example will be described in which the user monitors the water level of the river on the display 12 of the disaster measure headquarters.

The importance determination data acquisition unit 30 acquires the water level data of each river and a threshold value of the water level as the importance determination data. Here, in a case in which the water level data received in real time exceeds the threshold value acquired by the data threshold value acquisition unit 62, the data importance determination unit 28 determines that the importance of the water level data of that river is increased, and the screen configuration unit 26 arranges a water level data graph of that river to have a large display size. In order to secure the display region of the graph of which the size is to be increased, the screen configuration unit 26 does not display the water level data graph having low importance (having a margin up to the threshold value) in that case.

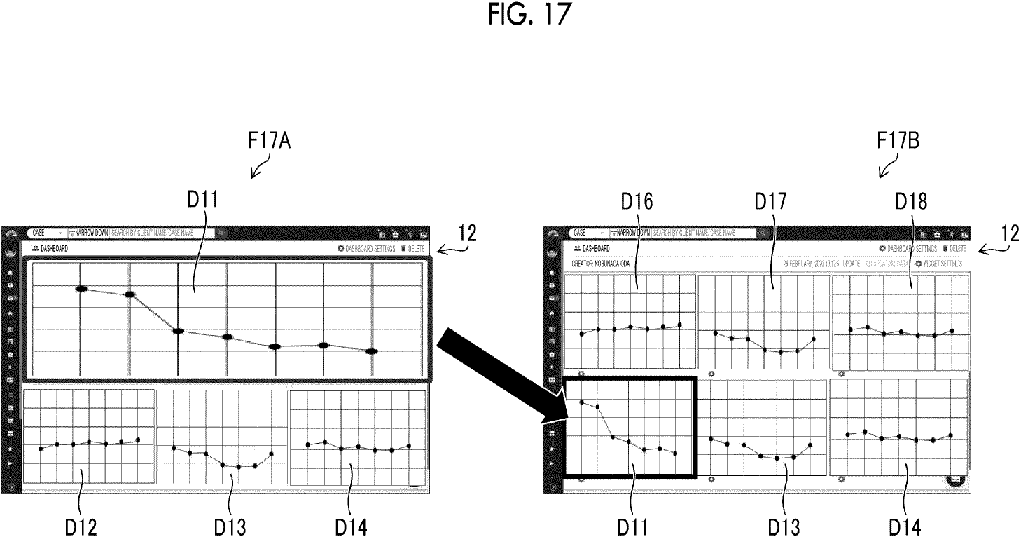

FIG. 16 is a diagram showing an example of the screen displayed on the display 12. Data D1, D2, D3, D4, D5, and D6 are the water level data of different rivers. A portion of F16A shown in FIG. 16 shows a screen arrangement in which the display sizes of the data D1 to D6 are the same display size.

Moreover, a portion of F16B shown in FIG. 16 shows a screen arrangement in which the display size of the data D4 is a relatively large display size, the display sizes of the data D1, D5, and D6 are relatively small display sizes, and the data D2 and D3 are not displayed. In a state of the portion of F16A, in a case in which the water level data of the data D4 exceeds the threshold value, the server 14 changes the screen arrangement shown in the portion of F16A to the screen arrangement shown in the portion of F16B.

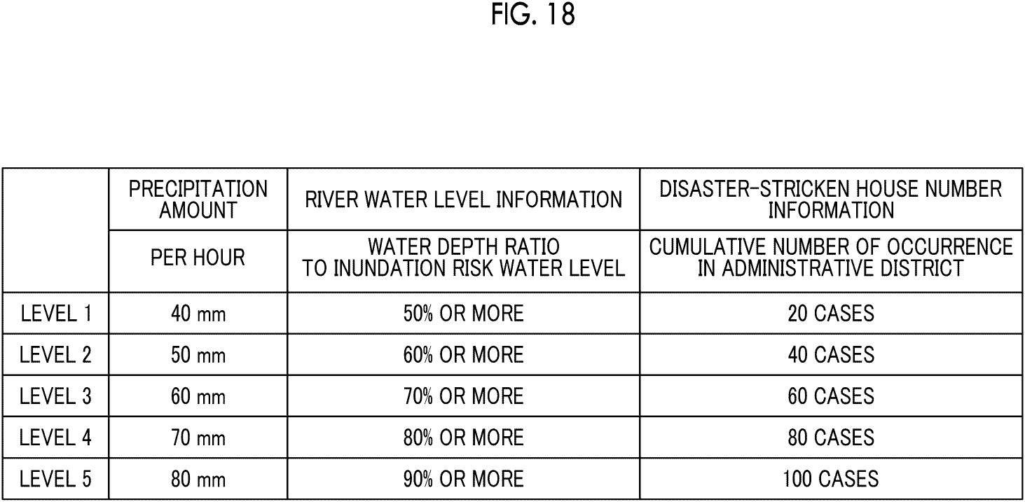

FIG. 17 is a diagram showing an example of the screen displayed on the display 12. A portion of F17A shown in FIG. 17 shows a screen arrangement in which a display size of data D11 is a relatively large display size and display sizes of data D12 to D14 are relatively small display sizes. Moreover, a portion of F17B shown in FIG. 17 shows a screen arrangement in which the display sizes of the data D11, D13, D14, and D16 to D18 are the same display size. In a case in which the water level data of the data D11 falls below the threshold value, the server 14 changes the screen arrangement shown in the portion of F17A to the screen arrangement shown in the portion of F17B.

In this way, by determining the importance from the water level data, it is possible to realize the screen display reflecting the dynamically changing importance for the user and the resident who perform monitoring at the disaster measure headquarters.

### Fifth Embodiment

In order for the data importance determination unit 28 to determine the importance of the plurality of types of data which are different, in each type of data, the user creates the reference table in advance regarding what value is determined and what importance is determined. Preferably, each of the plurality of types of data has a common level, for example, a level 1 to a level 5, such that the importance can be compared between the plurality of types of data.

FIG. 18 is a diagram showing an example of the reference table used by the data importance determination unit 28. In the example shown in FIG. 18, as the plurality of types of data, a precipitation amount [mm] per hour, river water level information which is a water depth ratio [%] to an inundation risk water level, and disaster-stricken house number information which is a cumulative number of occurrence [case] of disaster-stricken houses in an administrative district are included. The disaster-stricken house number information may be the number of cases per 10,000 residents or may be an occurrence frequency per unit time.

As shown in FIG. 18, the precipitation amount is defined as the level 1 in a case of 40 mm, the level 2 in a case of 50 mm, the level 3 in a case of 60 mm, the level 4 in a case of 70 mm, and the level 5 in a case of 80 mm. Moreover, the river water level information is the level 1 in a case of 50% or more, the level 2 in a case of 60% or more, the level 3 in a case of 70% or more, the level 4 in a case of 80% or more, and the level 5 in a case of 90% or more. Furthermore, the disaster-stricken house number information is set to the level 1 in a case of 20 cases, the level 2 in a case of 40 cases, the level 3 in a case of 60 cases, the level 4 in a case of 80 cases, and the level 5 in a case of 100 cases. It should be noted that the numerical values in FIG. 18 are for describing the present embodiment and are not used in actual disaster prevention administration.

In a case in which the reference table shown in FIG. 18 is used, for example, in a case in which the precipitation amount is 60 [mm], the river water level information is 60% or more, and the disaster-stricken house number information is 20 cases, the importance of the precipitation amount is the level 3, the importance of the river water level information is the level 2, and the importance of the disaster-stricken house number information is the level 1. Therefore, it can be seen that the importance of the precipitation amount is the highest and the importance of the disaster-stricken house number information is the lowest.

In this way, the importance of each of the plurality of types of data is calculated using the common indicator, and the importance is compared between the plurality of types of data using the importance calculated using the common indicator, so that it is possible for the user to grasp in real time the matters to be prioritized and dealt with, even in a case in which a large amount of data is collected due to a large-scale disaster.

This reference table corresponds to the importance determination data. The reference table is stored in the memory 14B in advance, and is acquired by the reference table acquisition unit 67 of the importance determination data acquisition unit 30.

Moreover, the data importance determination unit 28 may change the method of determining the importance according to the attribute of the user. For example, with respect to the data to be displayed on the screen of the tablet PC 18 of the investigator heading for the specific disaster site in the second embodiment, the data importance determination unit 28 may determine the importance of the data in the administrative district to which the specific disaster site belongs to be higher than the importance of the data in other administrative districts.

Moreover, with respect to the data to be displayed on the screen of the smartphone 20 of the resident in the third embodiment, the data importance determination unit 28 may determine the importance of the data in the administrative district in which the resident resides to be higher than the importance of data in other administrative districts.

### Others

The technical scope of the present invention is not limited to the range described in the embodiments described above. The configurations and the like in each embodiment can be appropriately combined between the respective embodiments without departing from the spirit of the present invention.

### EXPLANATION OF REFERENCES

10: damage situation monitoring system
12: display
14: server
14A: processor
14B: memory
14C: communication interface
16: information acquisition device
18: tablet PC
20: smartphone
21: communication network
22: external data reception unit
24: screen display unit
26: screen configuration unit
28: data importance determination unit
30: importance determination data acquisition unit
32: display/non-display control unit
34: layout control unit
36: cursor focus control unit
38: zoom control unit
40: color control unit
42: sound effect control unit
44: animation control unit
46: display position control unit
48: display layer control unit
50: size control unit
52: text color control unit
54: background color control unit
56: frame line color control unit
58: transparency effect control unit
59: sensor data reception unit
60: system log reception unit
61: data update frequency acquisition unit
62: data threshold value acquisition unit
63: metadata acquisition unit
64: user attribute acquisition unit
66: user feedback acquisition unit
67: reference table acquisition unit
68: user position acquisition unit
70: user gender acquisition unit
72: user age acquisition unit
74: biological information acquisition unit
A1: dynamic display region
A2: user input region
A3: fixed display region
A11 to A13, A21, A22: region
B1 to B3: button
D1 to D6: data
D11 to D18: data
S1 to S5: each step of screen display control method

What is claimed is:

1. A screen display control device comprising:
a memory that stores a command to be executed by a processor; and
the processor that executes the command stored in the memory,
wherein the processor
acquires a plurality of types of data that is input,
determines importance of each of the plurality of types of data,
decides an arrangement of display of the plurality of types of data on an entire screen based on the importance of each of the plurality of types of data, and
displays the plurality of types of data on the screen in the decided arrangement.

2. The screen display control device according to claim 1,
wherein the processor arranges a first type of data having high importance among the plurality of types of data to have a large area or arranges the first type of data to be more conspicuous than types of data other than the first type of data.

3. The screen display control device according to claim 1,
wherein, in a case in which importance of a second type of data among the plurality of types of data is increased, the processor arranges a third type of data having lowest importance among types of data other than the second type of data to have a small area or does not display the third type of data.

4. The screen display control device according to claim 1,
wherein the processor determines that a type of data of which a data input frequency exceeds a threshold value has high importance.

5. The screen display control device according to claim 1,
wherein the processor arranges a fourth type of data among the plurality of types of data to have a certain area.

6. The screen display control device according to claim 1,
wherein the processor displays a window that receives input from a user on the screen.

7. The screen display control device according to claim 1,
wherein the processor determines the importance of each of the plurality of types of data according to an attribute of a user or a position of the user.

8. The screen display control device according to claim 1,
wherein the processor
calculates the importance of each of the plurality of types of data using a common indicator, and
compares the importance of the plurality of types of data using the importance calculated using the common indicator.

9. The screen display control device according to claim 1,
wherein the plurality of types of data includes at least one of weather information, disaster measure information, earthquake disaster information, or flood damage information.

10. A screen display control method comprising:
an acquisition step of acquiring a plurality of types of data that is input;
a determination step of determining importance of each of the plurality of types of data;
a decision step of deciding an arrangement of display of the plurality of types of data on an entire screen based on the importance of each of the plurality of types of data; and
a display control step of displaying the plurality of types of data on the screen in the decided arrangement.

11. A non-transitory, computer-readable tangible recording medium on which a program for causing, when read by a computer, the computer to execute the screen display control method according to claim 10 is recorded.
